(19) United States
(12) Patent Application Publication
(10) Pub. No.: US 2013/0032060 A1
(43) Pub. Date: Feb. 7, 2013

(54) Modeling Composition

(71) Applicant: Liao Hong Cheng, Gongming (CN)

(72) Inventor: Liao Hong Cheng, Gongming (CN)

(73) Assignee: Tak Kai Terry Lee, Tai Tam (HK)

(21) Appl. No.: 13/195,436

(22) Filed: Aug. 1, 2011

(51) Int. Cl. C08L 3/00

(52) U.S. Cl. 106/217.3

(57) ABSTRACT

A modeling composition which is a non-toxic, malleable modeling compound for molding, extruding or sculpting use. Composition generally comprises wax, water, starch, filler, emulsifier, lubricant and coloring. When dried this modeling composition also creates a crayon.

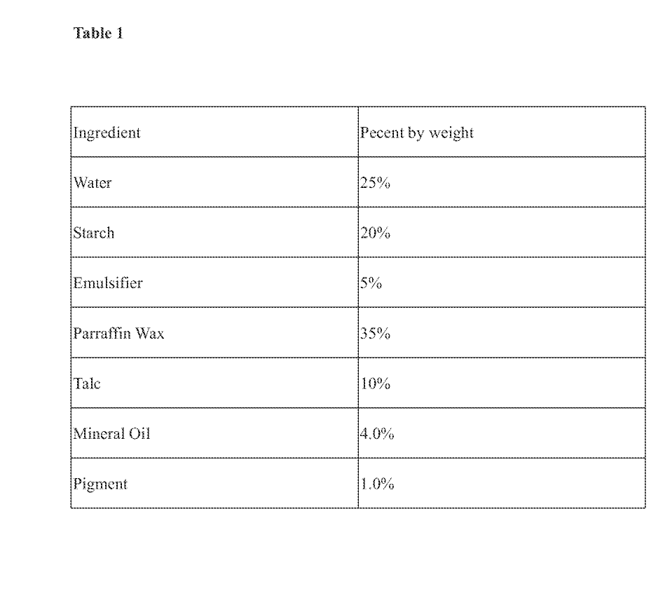

### TECHNICAL FIELD OF THE INVENTION

The present invention generally relates to a modeling compound for use as a play material suitable for young children. In particular the present intervention provides a non-toxic, malleable modeling compound for molding, extruding, or sculpting shapes or figures, and the modeling compound can be utilized as a crayon upon air drying.

### BACKGROUND OF THE INVENTION

Generations of children have been amused by modeling compounds that are important tools for aiding in the development of manual dexterity, fine motor skills and creativity. There are a number of specialty modeling compounds on the market today. The continuing need for improved and varied modeling compositions has prompted the development of a great variety of such modeling compounds with special features. For example, U.S. Pat. No. 5,498,645 discloses an improved water-based modeling dough which forms a solid, lightweight, durable product upon drying, U.S. Pat. No. 6,444,728 discloses a modeling lightweight dough which is excellent in lightweight, formability, shape preservation of the modeled shape, and bending deformation resistance of the modeled product obtained by modeling and drying. U.S. Pat. No. 5,873,933 discloses a Malleable play material compound resembling loose soil, which is formed by mixing a soluble cellulose, a polyvinyl alcohol, propylene glycol, water, sodium tetraborate, sodium carbonate and a light mineral oil. U.S. Pat. No. 5,506,290 discloses a plastic moldable composition which can be moldable, extrudable, stretchable, and inflated into bubbles for use as a play activity.

Accordingly, it is a general object of the present invention to provide an improved modeling composition with special features due to the continuing need in the art. More specifically, the present presentation provides a non-toxic, malleable modeling compound for molding, extruding, or sculpting shapes or figures, and the modeling compound can be utilized as a crayon upon air drying. Children can create their own crayons in different shapes easily. This provides additional play value to conventional modeling compound.

### BRIEF SUMMARY OF THE INVENTION

The present invention relates generally modeling composition. More particularly, the invention relates to a non-toxic, malleable modeling compound for molding, extruding, or sculpting shapes or figures, and the modeling compound can be utilized as a crayon upon air drying. The present composition comprises generally wax, water, starch, filler, emulsifier, lubricant and colorant. In one preferred form, the composition of the invention includes 20-80% wax, 10-60% water, 5-30% starch, 5-30% filler, 1-10% emulsifier, 1-10% lubricant and 0.1-10% colorant.

### BRIEF DESCRIPTION OF DRAWINGS

Table 1 is a general formulation for one embodiment.

### DESCRIPTION OF THE PREFERRED EMBODIMENTS

While the present invention is susceptible of embodiment in many different forms, as will be described herein in detail specific embodiments thereof with the understanding that the present disclosure is to be considered as an exemplification of the principles of the invention and is not intended to limit the invention to the specific embodiments illustrated.

To achieve the foregoing and other objects in accordance with the purposes of the present invention, as embodied and broadly claimed herein, the modeling compositions disclosed in the present invention comprises 20-80% wax, 10-60% water, 5-30% starch, 5-30% filler, 1-10% emulsifier, 1-10% lubricant and 0.1-10% colorant.

In a preferred embodiment, paraffin wax having a melting point of about 130° F.-150° F. is used in the present composition. Paraffin wax is a white and crystalline solid produced by refining and de-oiling the wax with the help of hydrogeneration refining equipments. Commercial paraffin wax is composed principally of normal paraffin of the C n H 2n+2 series and is a mixture of hydrocarbon with a average molecular weight of 300 to 500. It should be understood by those skilled in the art that other waxes may be utilized. For example, microcrystalline wax, carnauba wax, candelilla wax, beeswax or other petroleum derived waxes, mineral, vegetable, animal, synthetic waxes and their mixture thereof.

Starch is preferably added in the present composition from about 5% to about 30%. Starch is used as a binder and gives the present composition malleability, making the modeling compound feasible for molding, extruding, or sculpting shapes or figures. The starch-based binder can be selected from cornstarch, potato starch, tapioca starch, rice starch, glutinous rice starch, wheat flour, rye flour and their mixture thereof. Other water-soluble polymeric resin may also be utilized.

Talc in an amount from 5-30% is preferably added as filler in the present composition. Other fillers such as calcium carbonate clay, talc, barium sulfate, silica, aluminum oxide, titanium oxide and diatomaceous earth may be utilized. The lubricant can be selected from mineral spirits, mineral oil, and vegetable oil.

Emulsifier is preferably added in the present composition from about 1% to about 10%. This can help the dispersion of wax phase into the aqueous phase, yielding a modeling composition with smooth consistency and improved stability. Various emulsifiers that can be used in the present composition will be known to persons skilled in the art. Some examples of suitable emulsifiers include the group consisting of salts of saturated fatty acids, salts of straight-chain fatty acids, alkyl sulfosuccinates, alkyl phosphates, ethoxylated alcohols and polyoxyethylenesorbitan monostearate.

The present composition comprises a colorant, from about 0.1% to about 10% by weight, so that upon drying, the composition can be utilized as a marking device having various colors on a writing surface. A pigment is preferably used than a dye. For examples, phthalocyanine pigment, an indigo pigment, a quinacridone pigment, an anthraquinone pigment, a dioxazine pigment, a thioindigo pigment, a perinone pigment, a perylene pigment, an indolenone pigment, and an azo-azomethine pigment, titanium oxide and carbon black etc. However, the colorant used is not limited to the above.

Also, other additive, such as preservatives, fragrance material and embittering agent may be added to the formulation to enhance the function and the quality of the resulted modeling composition.

A general formulation of this disclosure is shown in Table 1.

Although several embodiments described above and by the claims serve to illustrate various concepts, components and techniques which are the subject of this patent, it is apparent to those of ordinary skill in the art that other embodiments incorporating these concepts, components and techniques may be used. It is understood that the scope of the following claims are not limited to the described embodiments and that many modifications and embodiments are intended to be included within the scope of the following claims. In addition the specific terms utilized in the disclosure and claims are used in a generic and descriptive sense and not for the purpose of limiting the invention described in the following claims.

I claim:

1. A modeling composition comprising wax, water, starch, filler, emulsifier, lubricant and colorant.

2. The modeling composition of claim 1 comprising 20-80% wax, 10-60% water, 5-10% starch, 5-30% filler, 1-10% emulsifier, 1-10% lubricant, and 0.1-10% colorant.

3. The modeling composition of claim 2, wherein the wax is preferably paraffin wax.

4. The modeling composition of claim 2, wherein the said starch can be selected from cornstarch, potato starch, tapioca starch, rice starch, glutinous rice starch, wheat flour and rye flour.

5. The modeling composition of claim 2, wherein the filler is preferably talc,

6. The modeling composition of claim 2, wherein the said lubricant can be selected from mineral spirits, mineral oil, and vegetable oil.

7. The modeling composition of claim 2, further comprising one or more of the following: preservative, scent, or embittering agent.
